(19) United States
(12) Patent Application Publication
(10) Pub. No.: US 2025/0193264 A1
(43) Pub. Date: Jun. 12, 2025

(54) WIRELESS COMMUNICATION METHOD AND DEVICE FOR EXTENDED REALITY TRAFFIC

(71) Applicant: SHENZHEN TCL NEW TECHNOLOGY CO., LTD., Shenzhen, Guangdong (CN)

(72) Inventors: Yincheng ZHANG, Shenzhen, Guangdong (CN); Jia SHENG, Shenzhen, Guangdong (CN)

(73) Assignee: SHENZHEN TCL NEW TECHNOLOGY CO., LTD., Shenzhen, Guangdong (CN)

(21) Appl. No.: 18/844,954

(22) PCT Filed: Mar. 7, 2022
(86) PCT No.: PCT/CN2022/079604

§ 371 Date: Sep. 7, 2024

(51) Int. Cl. H04L 65/65; H04L 47/24; H04L 47/34; H04L 67/131; H04L 69/22

(52) U.S. Cl. CPC H04L 65/65; H04L 47/24; H04L 47/34; H04L 67/131; H04L 69/22

(57) ABSTRACT

The disclosure provides a wireless communication method, executable in a wireless communication device operating as a transmitter device, comprising: receiving packets of a corresponding frame in an extended reality (XR) stream of an XR service, wherein each packet among the packets of the corresponding frame comprises a protocol data unit (PDU) header carrying a packet identity of the packet; configuring a transmission window based on the corresponding frame of the XR stream and a timer for the transmission window; determining whether to drop the packet associated with the packet identity based on the packet identity; delivering the packet to a lower layer when the packet identity of the packet is within a transmission window of the corresponding frame; and dropping the packet when the packet identity of the packet exceeds the transmission window of the corresponding frame.

### TECHNICAL FIELD

The present disclosure relates to the field of communication systems, and more particularly, to wireless communication method and device for extended reality (XR) traffic.

### BACKGROUND ART

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN comprises a set of base stations (BSs) that provide wireless links to the UEs located in cells covered by the base station, and an interface to a core network (CN) which provides overall network control. As will be appreciated the RAN and CN each conduct respective functions in relation to the overall network. The 3rd Generation Partnership Project has developed the so-called Long Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a gNB.

### Technical Problem

The 5G wireless communication system has been designed to deliver enhanced mobile broadband (eMBB), ultra-reliable low-latency communication (URLLC), and massive machine type communication (mMTC) services. In 5G or NR, features supporting eMBB, URLLC and mMTC was introduced in Release 15 and enhanced in Release 16 and 17.

Extended reality (XR) and cloud gaming service is an important media application enabled by 5G. In 3GPP, a series of study items have been done and discovered that XR service has some unique characteristics in the traffic profile while the current 5G system may not support XR service every well. Some characteristics of XR traffic are list in the following:
One of the unique characteristics of XR traffic is that each packet has an attribute of the frame. From a network transmission perspective, each video frame in XR services may be segmented into one or multiple packets. Generally, a video frame can only be decoded and reconstructed correctly if all its associated packets have been correctly received. Another characteristic of XR traffic is that XR service is time-sensitive, and each frame should arrive at the client of XR application in a required time window. As appreciated, it is meaningless to transmit obsolete packet(s) to a client terminal of an XR application. However, according to the current 3GPP architecture, the association between an XR frame and packets belonging to the XR frame is not discussed in NR standardization efforts. As a result, when some packets forming one frame arrive at a RAN (e.g., a UE or a base station in the RAN) and the RAN cannot transmit the packets in the required latency, the RAN may still try to transmit those packets without the knowledge of the association between the packets and the frame. That is, without the capability of identifying a frame and packets of the frame, the quality of service (QoS) of XR service cannot be guaranteed, and the network capacity could be degraded by potential unnecessary transmission.
Multiple data streams: according to the agreed traffic models for XR service in the Rel-17 XR study item (SI) in 3GPP RAN1, multiple stream models for downlink (DL) XR traffic have three options:
   Option 1: I-frame+P-frame;
   Option 2: video+audio/data; and
   Option 3: FOV+omnidirectional stream.

In Option 1, the I-frame is known as an intra-coded frame or an independent frame, and the P-frame is known as a predicted frame. In an XR service, an XR traffic flow of the Option 1 comprises a stream of I-frame and a stream of P-frame. In Option 2, the video, audio, and data respectively represent a video stream, an audio stream, and a data stream in an XR traffic flow. An XR traffic flow of the Option 2 comprises a video stream and an audio/data stream. In Option 3, FOV represents a stream of field of vision (FOV) in an XR traffic flow. An XR traffic flow of the Option 3 comprises a stream of FOV and an omnidirectional stream.

Multiple stream models for uplink (UL) XR traffic also have three options:
Option 2: pose/control+aggregating scene, video, data, and audio;
Option 3A: pose/control+aggregating streams of scene and video+aggregating streams of audio and data; and
Option 3B: pose/control+I-stream for video+P-stream for video.

In Options 2, 3A, and 3B of UL XR traffic, pose/control represents a stream of pose and control information of an XR traffic flow. Due to different delays caused by encoding/rendering and network delivery for different streams, different streams from the same XR service may have different data packet arrival times, even if all streams have the same periodicities and start time. However, from the perspective of smart radio bearer control and adaptive scheduling in RAN, synchronization between multiple streams based on packet or frame may be required by RAN to perform smart radio bearer control and adaptive scheduling for the stream(s) of XR traffic.

Hence, a method to address the packets for XR service is desirable.

### Technical Solution

An object of the present disclosure is to propose a user equipment (UE), a base station, and a wireless communication method.

In a first aspect, an embodiment of the invention provides a wireless communication method executable in a wireless communication device operating as a transmitter device, comprising: receiving packets of a corresponding frame in an extended reality (XR) stream of an XR service, wherein each packet among the packets of the corresponding frame comprises a protocol data unit (PDU) header carrying a packet identity of the packet;
configuring a transmission window based on the corresponding frame of the XR stream and a timer for the transmission window;
determining whether to drop the packet associated with the packet identity based on the packet identity; delivering the packet to a lower layer when the packet identity of the packet is within the transmission window of the corresponding frame; and dropping the packet when the packet identity of the packet exceeds the transmission window of the corresponding frame.

In a second aspect, an embodiment of the invention provides a wireless communication comprising a processor configured to call and run a computer program stored in a memory, to cause a device in which the processor is installed to execute the disclosed method.

The disclosed method may be implemented in a chip. The chip may include a processor, configured to call and run a computer program stored in a memory, to cause a device in which the chip is installed to execute the disclosed method.

The disclosed method may be programmed as computer executable instructions stored in non-transitory computer readable medium. The non-transitory computer readable medium, when loaded to a computer, directs a processor of the computer to execute the disclosed method.

The non-transitory computer readable medium may comprise at least one from a group consisting of: a hard disk, a CD-ROM, an optical storage device, a magnetic storage device, a Read-Only Memory, a Programmable Read-Only Memory, an Erasable Programmable Read-Only Memory, EPROM, an Electrically Erasable Programmable Read-Only Memory and a Flash memory.

The disclosed method may be programmed as a computer program product, which causes a computer to execute the disclosed method.

The disclosed method may be programmed as a computer program, which causes a computer to execute the disclosed method.

### Advantageous Effects

Embodiments of the invention provide:
A method for identifying packets of a frame in the transport network.
A method for transporting the identifier of a packet of a frame based on the Real-time Transport Protocol (RTP) protocol and RTP header extension.
A method for dropping obsolete packet(s) for a frame based on a timer, a transmission window, and an identifier identifying the frame.

### DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure. A person having ordinary skill in this field can obtain other figures according to these figures without paying the premise.

FIG. 1 illustrates a schematic view showing an example of a telecommunication system.

FIG. 2 illustrates a schematic view showing an embodiment of a network for the disclosed wireless communication method.

FIG. 3 illustrates a schematic view showing an example of protocol stacks of entities involved in an XR service.

FIG. 4 illustrates a schematic view showing a wireless communication method according to an embodiment of the disclosure.

FIG. 5 illustrates a schematic view showing a wireless communication method according to an embodiment of the disclosure.

FIG. 6 illustrates a schematic view showing an example of a downlink (DL) stream of an XR service.

FIG. 7 illustrates a schematic view showing an example of an uplink (UL) stream of an XR service.

FIG. 8 illustrates a schematic view showing an example of a protocol stack and XR packets.

FIG. 9 illustrates a schematic view showing another example of a protocol stack and XR packets.

FIG. 10 illustrates a schematic view showing an example of a potential protocol stack for an adaption layer in the disclosed method.

FIG. 11 illustrates a schematic view showing an example of an RTP general packet header.

FIG. 12 illustrates a schematic view showing an example of an RTP one-byte header.

FIG. 13 illustrates a schematic view showing an example of an RTP two-byte header.

FIG. 14 illustrates a schematic view showing a first example of an RTP header extension.

FIG. 15 illustrates a schematic view showing a second example of an RTP header extension.

FIG. 16 illustrates a schematic view showing a third example of an RTP header extension.

FIG. 17 illustrates a schematic view showing a fourth example of an RTP header extension.

FIG. 18 illustrates a schematic view showing an example of a transmission window.

FIG. 19 illustrates a schematic view showing an example of signaling for quality of service (QoS) requirements of an XR service.

FIG. 20 illustrates a schematic view showing a system for wireless communication according to an embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

This invention disclosed a wireless communication method for extended reality (XR) traffic to process packets of frames in extended reality (XR) service(s). XR service may include augmented reality (AR), virtual reality (VR), or mixed reality (MR).

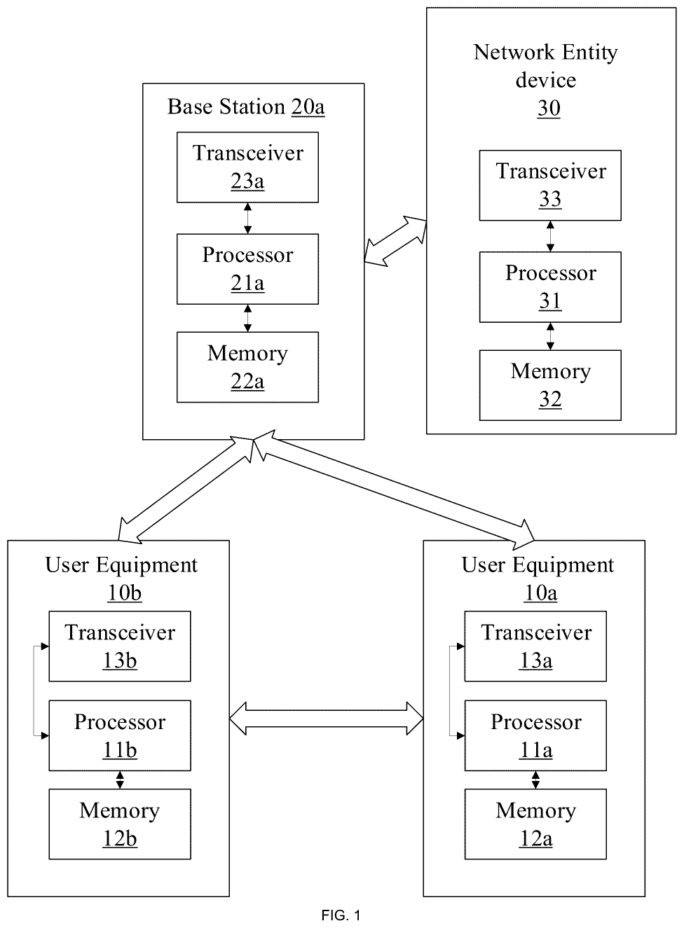

With reference to FIG. 1, a telecommunication system including a UE 10a, a UE 10b, a base station (BS) 20a, and a network entity device 30 executes the disclosed method according to an embodiment of the present disclosure. FIG. 1 is shown for illustrative, not limiting, and the system may comprise more UEs, BSs, and CN entities. Connections between devices and device components are shown as lines and arrows in the FIGS. The UE 10a may include a processor 11a, a memory 12a, and a transceiver 13a. The UE 10b may include a processor 11b, a memory 12b, and a transceiver 13b. The base station 20a may include a processor 21a, a memory 22a, and a transceiver 23a. The network entity device 30 may include a processor 31, a memory 32, and a transceiver 33. Each of the processors 11a, 11b, 21a, and 31 may be configured to implement proposed functions, procedures and/or methods described in the description. Layers of radio interface protocol may be implemented in the processors 11a, 11b, 21a, and 31. Each of the memory 12a, 12b, 22a, and 32 operatively stores a variety of programs and information to operate a connected processor. Each of the transceivers 13a, 13b, 23a, and 33 is operatively coupled with a connected processor, transmits and/or receives radio signals or wireline signals. The UE 10a may be in communication with the UE 10b through a sidelink. The base station 20a may be an eNB, a gNB, or one of other types of radio nodes, and may configure radio resources for the UE 10a and UE 10b.

The network entity device 30 may be a node in a CN. CN may include LTE CN or 5G core (5GC) which includes user plane function (UPF), session management function (SMF), 5G core access and mobility management function (AMF), unified data management (UDM), policy control function (PCF), control plane (CP)/user plane (UP) separation (CUPS), authentication server (AUSF), network slice selection function (NSSF), and the network exposure function (NEF).

An example of the UE in the description may include one of the UE 10a or UE 10b. An example of the base station in the description may include the base station 20a. Uplink (UL) transmission of a control signal or data may be a transmission operation from a UE to a base station. Downlink (DL) transmission of a control signal or data may be a transmission operation from a base station to a UE. A DL control signal may comprise downlink control information (DCI) or a radio resource control (RRC) signal, from a base station to a UE.

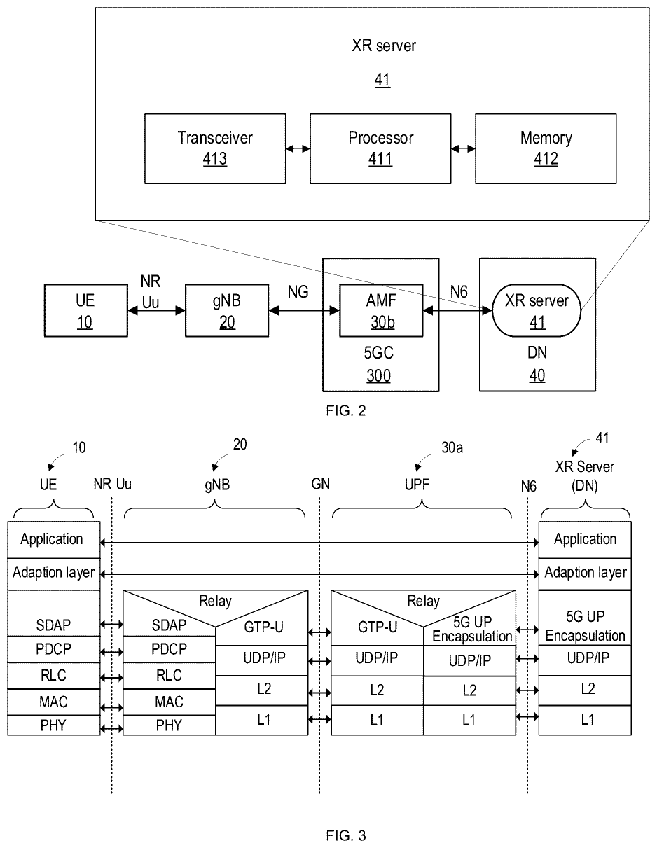

FIG. 2 is a model of a transport network for XR service supported by 5G system. A UE 10 is a 5G terminal which can support XR service and XR application and can be referred to as a client, a client terminal, or an XR client. A gNB 20 is 5G radio node. The gNB 20 communicates with the UE 10 and provides NR user plane and control plane protocol terminations towards the UE via NR Uu interface. The gNB 20 connects via the NG interface to a 5GC 300. A UPF 30b is a UPF in the 5GC 300 which is a 5G Core Network. DN 40 is a data network (DN) 40 where an XR server 41 providing XR service is located. The DN 40 can provide network operator services, Internet access, or 3rd party services. The XR server 41 may include a processor 411, a memory 412, and a transceiver 413. The processor 411 may be configured to implement XR service related functions, procedures and/or methods described in the description. Layers of radio interface protocol may be implemented in the processor 411. The memory 412 operatively stores a variety of programs and information to operate a connected processor. The transceiver 413 is operatively coupled with a connected processor, transmits and/or receives radio signals or wireline signals.

Each of the processors 411, 11a, 11b, 21a, and 31 may include an application-specific integrated circuit (ASICs), other chipsets, logic circuits and/or data processing devices. Each of the memory 412, 12a, 12b, 22a, and 32 may include read-only memory (ROM), a random access memory (RAM), a flash memory, a memory card, a storage medium and/or other storage devices. Each of the transceivers 413, 13a, 13b, 23a, and 33 may include baseband circuitry and radio frequency (RF) circuitry to process radio frequency signals. When the embodiments are implemented in software, the techniques described herein may be implemented with modules, procedures, functions, entities, and so on, that perform the functions described herein. The modules may be stored in a memory and executed by the processors. The memory may be implemented within a processor or external to the processor, in which those may be communicatively coupled to the processor via various means are known in the art. A device executing the wireless communication method may be a transmitter device that transmits an XR traffic flow of an XR service to a receiver device or a receiver device that receives the XR traffic flow. The XR traffic flow may comprise one or more XR streams of the XR service. For example, the device executing the wireless communication method may comprise the gNB 20, an XR server 41 in data network 40, or a UE. That is, the XR server 41 in data network 40 may operate as a transmitter device that executes a wireless communication method in some XR traffic delivery occasions, while the UE 10 operates as the receiver device receiver the XR traffic flow sent from the transmitter device. Similarly, the UE 10 may operate as a transmitter device to execute a wireless communication method in some XR traffic delivery occasions, while the XR server 41 operates as the receiver device receiver the XR traffic flow sent from the transmitter device. Alternatively, the transmitter device may comprise an intermediate device between the UE 10 and the XR server 41. The UE 10 may comprise an embodiment of the UE 10a or UE 10b. The gNB 20 may comprise an embodiment of the base station 20a. Note that although the gNB 20 and UPF/5GC 30b are described as an example in the description, the wireless communication method may be executed by a base station, such as another gNB, an eNB, a base station integrating an eNB and a gNB, or a base station for beyond 5G technologies. The UPF/5GC 30b may comprise another network entity of 5GC.

one or more steps (or blocks) in of embodiments of the disclosure may be implemented as computer programs, instructions, software module(s) stored in a memory of the transmitter device, or circuits or hardware module(s) in a processor of the transmitter device, or IC chip(s), circuits, or plug-in(s) of the transmitter device.

FIG. 3 shows an example of overall protocol stacks between the UE 10 and the XR server 41 including intermediate entities (i.e., gNB 20 and UPF 30a). Communications between any couple of entities in the same protocol layer are shown as arrows. Protocol layers in FIG. 3 have been standardized and are briefly explained in the following:
Adapt Layer: A virtual stack or layer which adapts the application data into packets with an appropriate format for the transport network or from packets with the appropriate format from the transport network. The adaption layer would be standardized by 3GPP and may include one or more sublayers which may reference one or more existing specifications.
5G UP Encapsulation: A virtual stack or layer which would be standardized by 3GPP to an appropriate specification, such as GTP-U;
L1: The physical layer of Internet which can be any suitable layer 1 technique, such as point-to-point or point-to-multipoint techniques;
L2: The data link layer of Internet which can be any suitable Data Link Layer protocol, such as point-to-point protocol (PPP), Ethernet, etc.;
IP: “Internet Protocol”, which can be referred to in IETF RFC 791, or “Internet Protocol, Version 6 (IPv6) Specification” in IETF RFC 8200;
UDP: “User Datagram Protocol”, which can be referred to in IETF RFC 768 (1980-08);
GTP-U: “General Packet Radio System (GPRS) Tunnelling Protocol User Plane (GTPv1-U)”, which can be referred to in 3GPP TS 29.281;
PHY: The physical layer of NR, which can be referred to in 3GPP TS 38.211 to 38.215;
MAC: NR Medium Access Control (MAC) protocol, which can be referred to in 3GPP TS 38.321;
RLC: NR Radio Link Control (RLC) protocol, which can be referred to in 3GPP TS 38.322;
PDCP: NR; Packet Data Convergence Protocol (PDCP), which can be referred to in 3GPP TS 38.323; and
SDAP: Service Data Adaptation Protocol (SDAP) of Evolved Universal Terrestrial Radio Access (E-UTRA) and NR, which can be referred to in 3GPP TS 37.324.
   Each layer of the one or more protocols may be implemented as a module, an entity, or a unit for processing the one or more protocols. For example, the application layer in the transmitter device (e.g., the UE 10 or the XR server 41) or the receiver device (e.g., the XR server 41 or the UE 10) may comprise an application entity of the transmitter device or the receiver device. Similarly, the adaption layer in the transmitter device (e.g., the UE 10 or the XR server 41) or the receiver device (e.g., the XR server 41 or the UE 10) may comprise an adaption entity of the transmitter device or the receiver device. The SDAP layer in the transmitter device, the receiver device, or an intermediate device (e.g., the gNB 20 or the UPF 30a) may comprise an SDAP entity of the transmitter device, the receiver device, or the intermediate device. The PDCP layer in the transmitter device, the receiver device, or an intermediate device may comprise a PDCP entity of the transmitter device, the receiver device, or the intermediate device. The RLC layer in the transmitter device, the receiver device, or an intermediate device may comprise an RLC entity of the transmitter device, the receiver device, or the intermediate device. The MAC layer in the transmitter device, the receiver device, or an intermediate device may comprise an MAC entity of the transmitter device, the receiver device, or the intermediate device. The PHY layer in the transmitter device, the receiver device, or an intermediate device may comprise a PHY entity of the transmitter device, the receiver device, or the intermediate device. The 5G UP encapsulation layer in the transmitter device, the receiver device, or an intermediate device may comprise a 5G UP encapsulation entity of the transmitter device, the receiver device, or the intermediate device. The GTP-U layer in the transmitter device, the receiver device, or an intermediate device may comprise a GTP-U entity of the transmitter device, the receiver device, or the intermediate device. The UDP/IP layer in the transmitter device, the receiver device, or an intermediate device may comprise a UDP/IP entity of the transmitter device, the receiver device, or the intermediate device. The L2 layer in the transmitter device, the receiver device, or an intermediate device may comprise an L2 entity of the transmitter device, the receiver device, or the intermediate device. The L1 layer in the transmitter device, the receiver device, or an intermediate device may comprise an L1 entity of the transmitter device, the receiver device, or the intermediate device.

A video stream of an XR service will be encoded and compressed in form of frames quasi-periodically with the respective frame periodicity of 1/60, 1/90, or 1/120 second. Since the transmitter device may divide a video stream of an XR service into a number of transport units, encapsulate and transmit each of the transport units into a transport packet transmitted across the network, the transmission mechanism of the XR service is actually based on packet instead of frame. The size of each of the packets may be variable, the number of the packets may be variable and configurable based on one or more parameters of the QoS requirements and characteristics of the XR service, such as packet delay budget (PDB), packet error rate (PER), packet loss rate (PLR), frame error rate, frame delay budget, resolution, frame rate, and/or data rate.

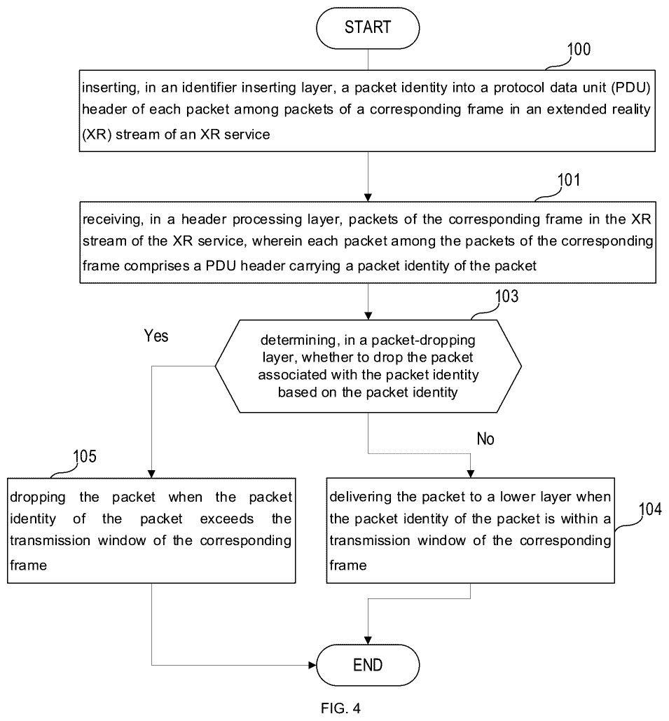

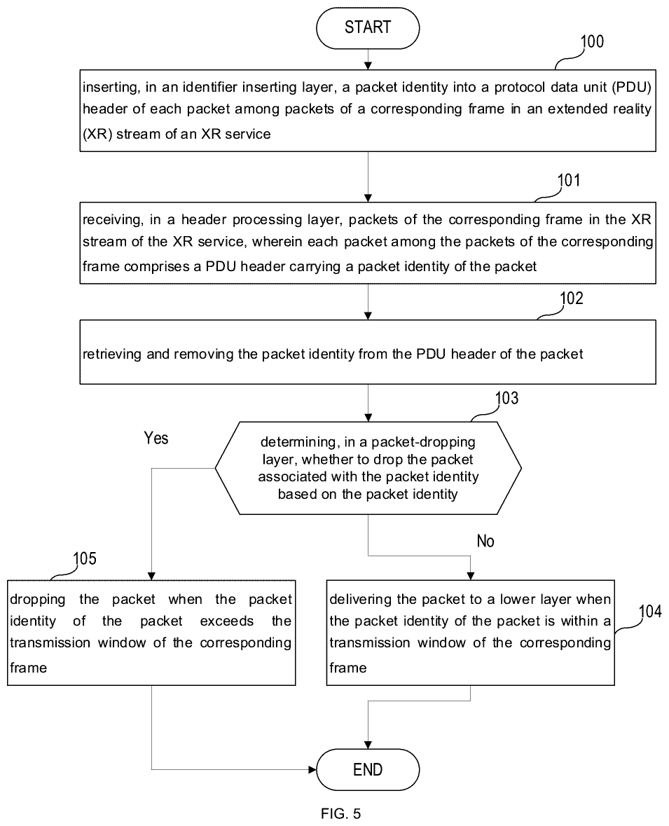

With reference to FIG. 4 and FIG. 5, the transmitter device executes an embodiment of the disclosed method.

An embodiment of the disclosure provides a wireless communication method for identifying a packet of a frame, inserting an identifier of the frame into the packet, and transporting the packet in a transport network or dropping the packet as an obsolete packet based on the identifier.

An embodiment of the disclosed method comprises the following steps to identify and process packets of a frame:
Inserting, in an identifier inserting layer, a packet identity into a protocol data unit (PDU) header of each packet among packets of a corresponding frame in an XR stream of an XR service (block 100), wherein the packet identity comprises at least one of a frame identifier or a packet identifier, the frame identifier can at least uniquely identify a frame of the packets among a predefined number of consecutive different frames of the XR stream, and the packet identity is defined so as to identify each packet of a frame or all the packets of a frame;
receiving, in a header processing layer, packets of the corresponding frame in the XR stream of the XR service, wherein each packet among the packets of the corresponding frame comprises a PDU header carrying a packet identity of the packet (block 101);
determining, in a packet-dropping layer, whether to drop the packet associated with the packet identity based on the packet identity (block 103);
delivering the packet to a lower layer when the packet identity of the packet is within a transmission window of the corresponding frame (block 104); and
dropping the packet when the packet identity of the packet exceeds the transmission window of the corresponding frame (block 105).

The packet identity is a temporary identifier since the packet identity is inserted into a PDU header by the adaption layer (or the application layer) of the transmitter device and removed by a header processing layer of the transmitter device. The packet identity is a frame-packet association identifier since the packet identity associates a plurality of packets to one corresponding frame. The packet identity is an inter-layer message since the packet identity is generated by the adaption layer (or the application layer) of the transmitter device and processed and removed by the header processing layer of the transmitter device.

With reference to FIG. 5, the embodiment of the disclosed method further comprises retrieving and removing the packet identity from the PDU header of the packet (block 102).

In an embodiment, the inserting of the packet identity into the PDU header of each packet among the packets of the corresponding frame is performed in an identifier inserting layer at a source point of the XR stream of the XR service.

In an embodiment, the retrieving and removing of the packet identity from the PDU header of the packet is performed in a header processing layer of the transmitter device.

In an embodiment, the determining as to whether to drop the packet associated with the packet identity, the delivering of the packet, and the dropping of the packet are performed in a packet-dropping layer of the transmitter device.

In an embodiment, the identifier inserting layer comprises an application layer or an adaption layer of the transmitter device.

In an embodiment, the header processing layer comprises a packet data convergence protocol (PDCP) layer or a service data adaptation protocol (SDAP) layer of the transmitter device.

In an embodiment, the packet-dropping layer comprises a packet data convergence protocol (PDCP) layer or a radio link control (RLC) layer of the transmitter device.

An embodiment of the disclosed method comprises the following steps to identify and process packets of a frame:
a frame processing layer (e.g., an application layer or an adaption layer) inserting a packet identity into a protocol data unit (PDU) header of the adaption layer for each packet among packets of a corresponding frame in an XR stream of an XR service, wherein the packet identity comprises at least one of a frame identifier or a packet identifier, the frame identifier can at least uniquely identify a frame of the packets among a predefined number of consecutive different frames of the XR stream, and the packet identity is defined so as to identify each packet of a frame or all the packets of a frame;
a header processing layer (e.g., a PDCP layer) retrieving and removing the packet identity from the PDU header of one packet among packets of the corresponding frame; and
determining whether to drop the packet associated with the packet identity based on the packet identity in packet-dropping layer;
the packet-dropping layer delivering the packet to a lower layer (e.g., an RLC layer) when the packet identity of the packet is within a transmission window of the corresponding frame; and
the packet-dropping layer dropping the packet when the packet identity of the packet is not bounded within the transmission window of the corresponding frame.

PDCP stands for packet data convergence protocol (PDCP), and RLC stands for radio link control (RLC). The retrieving and removing of the packet identity may be executed in a PDCP layer or an SDAP layer. In the description, a packet identity may be referred to as an identifier for abbreviation, and an obsolete packet is a packet of a frame, which does not conform to a time requirement of the frame. For example, the time requirement requires that packets of the frame should be transported within a transmission window defined for the frame. A frame (e.g., video frame) of an XR service may be segmented into one or multiple packets for transmission on a network. The multiple packets may be referred to as packets corresponding to the frame or corresponding packets of the frame. The frame may be referred to as a frame corresponding to the packets or a corresponding frame of the packets.

In an embodiment of the disclosed method, the packet identity of a packet of a frame is transported using Real-time Transport Protocol (RTP) protocol and may be inserted into an RTP header extension:
In an RTP PDU, the field “X” in the RTP header should be set to “1”;
AN RTP header extension is used to transport the identifier of a packet of a frame.

A transmitter device of an XR stream of an XR service may execute an embodiment of the disclosed method to drop obsolete packet(s) for a frame based on the following factors:
a configurable timer and/or transmission window;
the packet identity is a frame serial number (SN) of each packet.

### Identify a Packet of a Frame:

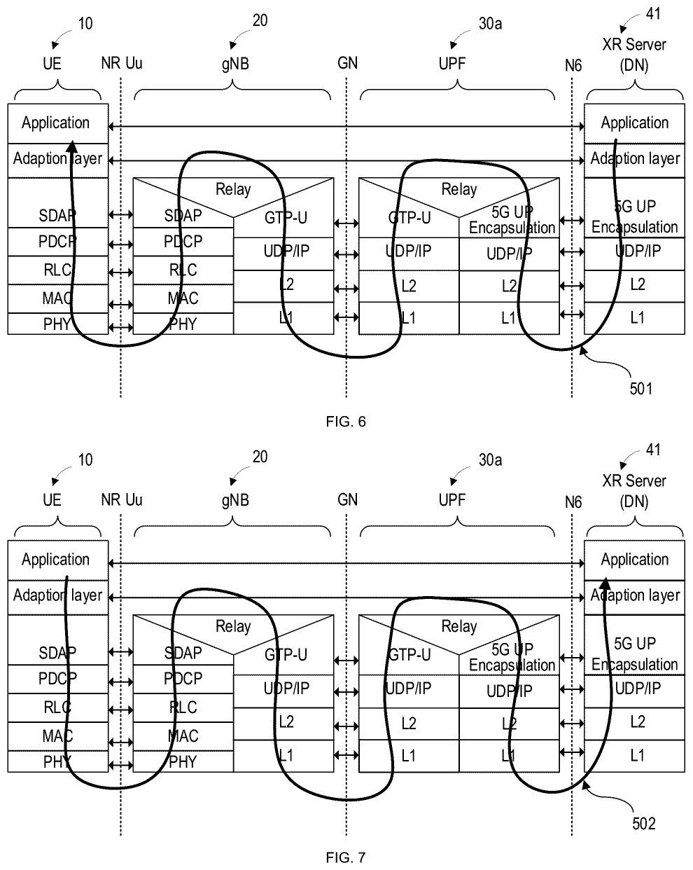

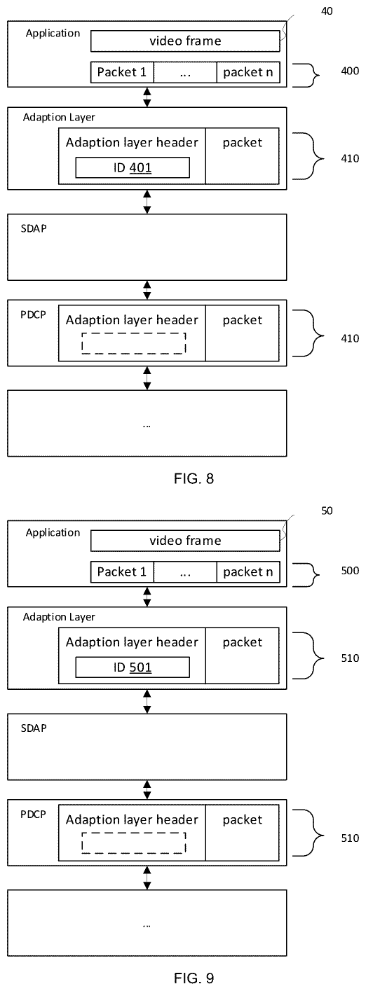

As illustrated in FIGS. 6 and 8, an embodiment of the disclosed method for a downlink (DL) XR stream 501, i.e., from the XR server 41 to an XR client (e.g., UE 10), comprises steps detailed in the following:
An XR frame (e.g., a video frame) 40 from an XR application in the application layer may be segmented into one or multiple packets 400 in the adaption layer. For each packet 410, the adaption layer inserts a packet identity 401 into an adaption layer header of the packet 410, and delivers the packet 410 to an SDAP layer. The SDAP layer process the packet as a protocol data unit (PDU) by adding an SDAP header to the packet. The SDAP layer transmits the packet as a service data unit (SDU) to the PDCP layer.
The PDCP layer, when receiving the SDU from the SDAP layer, retrieves and removes the packet identity 401 from the adaption layer header, compresses and delivers the packet to the RLC layer and lower layers (i.e., MAC and PHY layers) for transmission through the RAN and 5GC.

Packets of frames of the DL XR stream 501 is sent from the application layer (i.e., a source point of the DL XR stream 501) of the XR server 41 to the application layer (i.e., a source point of the DL XR stream 501) of the application layer (i.e., a destination of the DL XR stream 501) of the UE 10. As shown in FIG. 6, the packets in the DL XR stream 501 are processed by layers along the DL XR stream 501. Note that in an embodiment, the inserting of the packet identity may be performed in the adaption layer of the XR server 41, while the determining as to whether to drop the packet associated with the packet identity and the dropping are performed in the PDCP layer of the gNB 20.

As illustrated in FIGS. 7 and 9, for the uplink video stream 502, i.e., from an XR client (e.g., UE 10) to the XR server 41, the corresponding detailed process is similar to that for the downlink.
An XR frame (e.g., a video frame) 50 from an XR application in the application layer of the XR server 51 may be segmented into one or multiple packets 500 in the adaption layer. For each packet 510, the adaption layer inserts a packet identity 501 into an adaption layer header of the packet 510, and delivers the packet 510 to an SDAP layer. The SDAP layer process the packet as a protocol data unit (PDU) by adding an SDAP header to the packet. The SDAP transmits the packet as a service data unit (SDU) to the PDCP layer.
The PDCP layer, when receiving the SDU from the SDAP layer, retrieves and removes the packet identity 501 from the adaption layer header, compresses and delivers the packet to RLC layer and lower layers (i.e., MAC and PHY layers) for transmission through the RAN and 5GC.

The inserting is performed in the adaption layer, and the retrieving is performed in the PDCP layer in UE 10. For the retrieving and removing function in the PDCP layer, the retrieving and removing function may be a part of the function of header compression or a separate function in the PDCP layer.

Packets of frames of the UL XR stream 502 is sent from the application layer (i.e., a source point of the UL XR stream 502) of the UE 10 to the application layer (i.e., a source point of the UL XR stream 502) of the application layer (i.e., a destination of the UL XR stream 502) of the XR server 41. As shown in FIG. 7, the packets in the UL XR stream 502 are processed by layers along the UL XR stream 502. Note that in an embodiment, the inserting of the packet identity may be performed in the adaption layer of the UE 10, while the determining as to whether to drop the packet associated with the packet identity and the dropping are performed in the PDCP layer of the UE 10 or the PDCP layer of gNB 20.

In another embodiment, the retrieving and removing function (i.e., retrieving and removing of the packet identity) of the packet identity is located in the SDAP layer.

### Frame-Level Identifier:

The packet identity may be the SN of the corresponding XR frame (e.g., video frame) so that all the packets for one frame may have the same packet identity.

### Packet-Level Identifier and Frame-Level Identifier:

In another embodiment, the packet identity of each packet corresponding to a frame comprises an identifier for the packet and an identifier for the corresponding frame. The identifier for the packet is a packet-level identifier for identifying the packet among packets corresponding to the frame, and the identifier for the corresponding frame is a frame-level identifier for identifying, among a plurality of frames, the frame corresponding to the packet. For example, the identifier for the packet is a packet serial number (SN) for the packet in the frame, and the identifier for the corresponding frame is a frame SN of the frame.

The packet SN may be counted up or counted down as a counting sequence of a modulus counter, so that the packet SN is reset to an initial SN upon an end (i.e., overflow or underflow) of the counting sequence of the counter. Similarly, the frame SN may be counted up or counted down as a counting sequence of another modulus counter, so that the frame SN is reset to an initial SN upon an end (i.e., overflow or underflow) of a counting sequence of the counter. The packet SN and/or the frame SN can be generated locally in the adaption layer or received from the application layer.

### Transport the Identifier a Packet of a Frame Using RTP Header Extension:

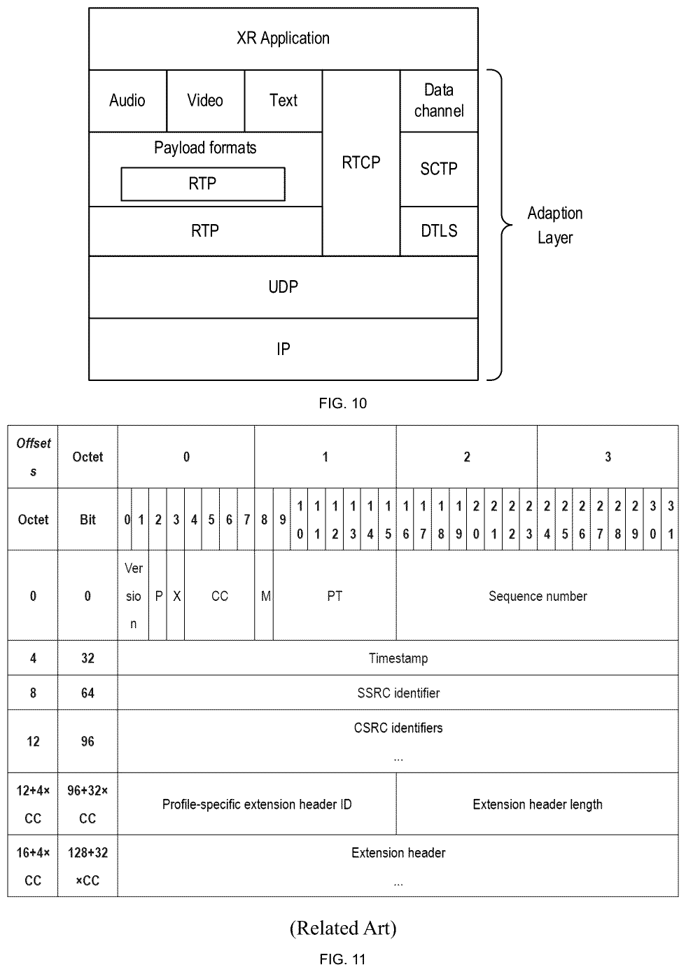

FIG. 10 shows an example of a potential protocol stack for the adaption layer in the disclosed method. This model comprises multiple protocol sublayers, and the RTP protocol is used to transport the packets of frames for an XR service. The packet identity is inserted into a header extension of a real-time transport protocol (RTP) header in the PDU header.

As well known, the RTP protocol is designed for end-to-end, real-time transfer of streaming media. The protocol provides facilities for jitter compensation and detection of packet loss and out-of-order delivery, which are common, especially during UDP transmissions on an IP network. The RTP general packet header is illustrates in FIG. 11.

Some of the fields of the RTP header are as follow:
X (Extension): A 1-bit field which indicates presence of an extension header between the header and payload data of a packet. The extension header may be application-specific or profile-specific.
Header extension: An optional field, the presence of which is indicated by the Extension field (i.e., the field X). The first 32-bit word in the header extension contains a profile-specific identifier (16 bits) and a length indicator (16 bits) that indicates the length of the extension in 32-bit units, excluding the 32 bits of the extension header. The extension header data content is detailed in the following.

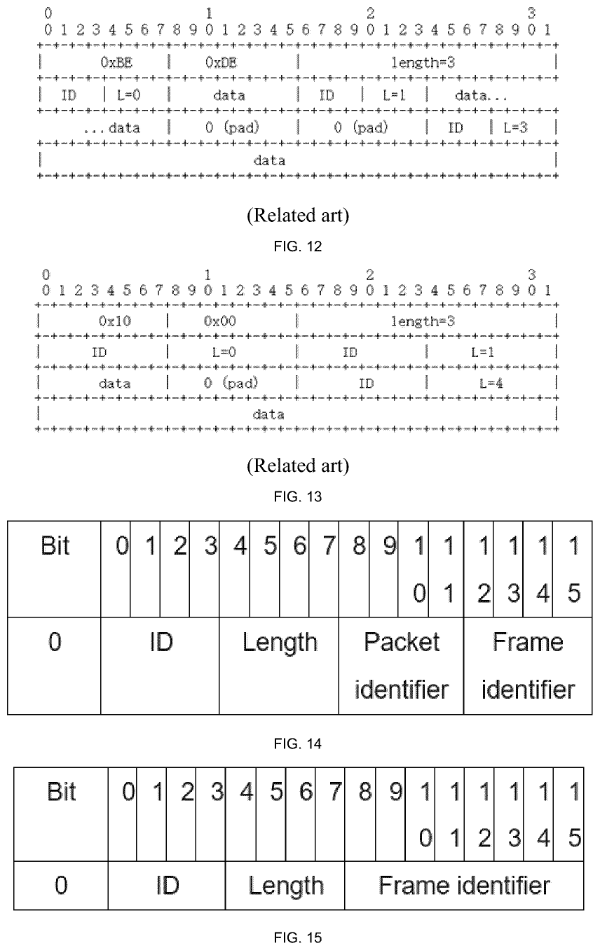

Moreover, in the last version of RTP (RFC 5285), two types of extension header are adopted, comprising a one-byte header and two-byte header, as detailed in the following:
One-Byte Header:
   With reference to FIG. 12, a one-byte header comprises the following fields:
      0xBE: one-byte header;
      0xDE: one-byte header;
      Length=3: three extended headers;
      L=0: length of the data following L extension head.
Two-Byte Header:
   With reference to FIG. 13, a two-byte header comprises a plurality of fields.

The invention provides various embodiments of a wireless communication method to transport a packet identity of a packet of a frame based on the RTP protocol and RTP header extension.

With reference to FIG. 14, in one embodiment, an RTP PDU and its One-Byte header extension are defined in the following:
In the RTP PDU, the field “X” is set “1” to indicate that one or more header extensions carrying the packet identity are in the RTP header;
A header extension is attached to identify a packet of a frame in the following format:
   The field “ID” of a header extension may be predefined or generated dynamically and has a length of 4 bits.
   The field “L” of a header extension represents the number of data field(s) for the packet identifier and/or frame identifier. For example, the field “L” may be set to “1” to indicate only one byte data field which includes two sub-fields, one for the packet identifier and the other for the frame identifier, each of which is 4 bits in length.
   A packet identifier identifies a packet uniquely among packets corresponding to a frame of an XR stream of an XR service. For example, a packet identifier of each packet may be the SN of the packet in a frame, and the maximum number of packets in a frame is 16.
   A frame identifier identifies one frame corresponding to the packet in a predefined number of consecutive frames and is incremented for each frame predefined number of consecutive different frames. For example, a frame identifier of each frame may be the frame SN of the frame. The predefined number of frame SN is 16.

With reference to FIG. 15, in another embodiment, an RTP PDU and its One-Byte header extension are defined in the following:
In the RTP PDU, the field “X” should be set “1” to indicate that one or more header extensions carrying the packet identity are in the RTP header;
A header extension is attached to identify the packets in the same frame in the following format.
   The field “ID” of a header extension may be predefined or generated dynamically and has a length of 4 bits.
   The field “L” of a header extension represents the number of data field(s) for the packet identifier and/or frame identifier. For example, the field “L” may be set to “1” to indicate only one byte data field for the frame identifier.
   A frame identifier identifies one frame corresponding to the packet in a predefined number of consecutive frames and is incremented for each frame predefined number of consecutive different frames. For example, a frame identifier of each frame may be the frame SN of the frame. The predefined number of frame SN is 256.
   For each packet of the same frame, the frame identifier is the same.

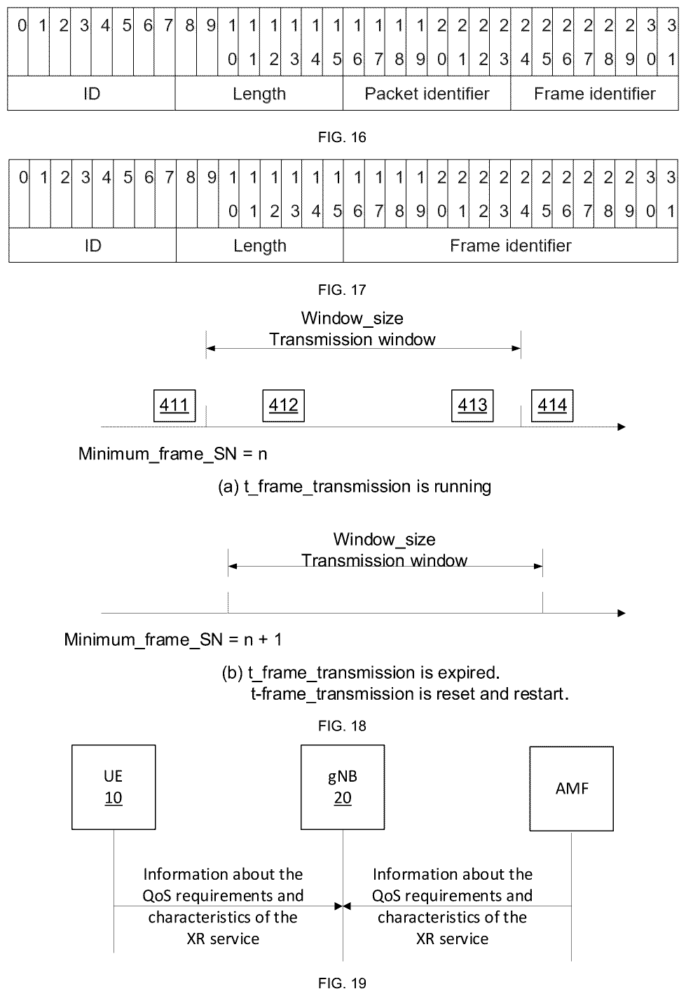

With reference to FIG. 16, in another embodiment, an RTP PDU and its Two-Byte header extension are defined longer in the following:
In the RTP PDU, the field “X” should be set “1” to indicate that one or more header extensions carrying the packet identity are in the RTP header;
A header extension is attached to identify the packets in the same frame in the following format.
   The field “ID” of a header extension may be predefined or generated dynamically.
   The field “L” of a header extension represents the number of data field(s) for the packet identifier and/or frame identifier. For example, the field “L“may be set to” 2” to indicate 2 bytes data field which includes two sub-fields, one for the packet identifier and the other the frame identifier, each of which is 1 byte in length.
   A packet identifier identifies a packet uniquely among packets corresponding to a frame of an XR stream of an XR service. For example, a packet identifier of each packet may be the SN of the packet in a frame, and the maximum number of packets in a frame is 256.
   A frame identifier identifies one frame corresponding to the packet in a predefined number of consecutive frames and is incremented for each frame predefined number of consecutive different frames. For example, a frame identifier of each frame may be the frame SN of the frame. The predefined number of frame SN is 256.

With reference to FIG. 17, in another embodiment, an RTP PDU and its Two-Byte header extension are defined long in the following:
In the RTP PDU, the field “X” should be set “1” to indicate that one or more header extensions carrying the packet identity are in the RTP header;
A header extension is attached to identify the packets in the same frame in the following format.
   The field “ID” of a header extension may be predefined or generated dynamically and has a length of 1 byte;
   The field “L” of a header extension represents the number of data field(s) for the packet identifier and/or frame identifier. For example, the field “L“may be set to” 2” to indicate two bytes data field for the frame identifier.
   A frame identifier identifies one frame corresponding to the packet in a predefined number of consecutive frames and is incremented for each frame predefined number of consecutive different frames. For example, a frame identifier of each frame may be the frame SN of the frame. The predefined number of frame SN is 65536.
   For each packet of the same frame, the frame identifier is the same.

### Packet Dropping:

XR service is time-sensitive and each packet for a frame should arrive at the client of an XR application within a required time latency. If a packet is not useful for a decoder (or a decompressor) at an XR receiver (e.g., UE 10 or XR server 41) since decoding/decompression operations in the decoder (or the decompressor) have moved to the packets for the later frame(s), the packet is an obsolete packet and can be discarded as soon as possible. In other words, transmitting obsolete packet(s) is unnecessary and inefficient, and may waste the network capacity of RAN or CN.

With reference to FIG. 18, the transmitter device executes an embodiment of the disclosed method to drop the obsolete packet (e.g., packets 411 and 414) based on a timer and a transmission window. The timer and the transmission window are refreshed for each frame of an XR stream of an XR service. In an embodiment, the timer denoted as a timer t_frame_transmission is configured to time the transmission window in a time domain, and the transmission window has a window size denoted as Window_size and is delimited by a minimum frame SN Minimum_frame_SN and a maximum frame SN obtained from Minimum_frame_SN+Window_size. That is, the transmission window is a range defined by the minimum frame SN Minimum_frame_SN and the maximum frame SN. The maximum frame SN is determined by the minimum frame SN and a predefined window size of the transmission window. The transmission window slides when the timer expires by means of adding one or a predefined value to the minimum frame SN to form a new value of the minimum frame SN of the transmission window. When the transmitter device processes an XR stream of an XR service, among frames of the transmitter device, a packet (e.g., packets 412 or 413) of a corresponding frame arriving at the packet-dropping layer (e.g., a PDCP layer or an SDAP layer) within the transmission window of the corresponding frame is a packet conforming to latency requirements of the XR service, and a packet (e.g., packets 411 or 414) of a corresponding frame arriving at the packet-dropping layer outside the transmission window of the corresponding frame is an obsolete packet not conforming to the latency requirements of the XR service.

In one embodiment, the frame identifier is the frame SN. The packet identity comprises a frame SN of the corresponding frame. A packet of the corresponding frame is within the transmission window of the corresponding frame if the frame SN is in a range defined by the minimum frame SN and the maximum frame SN. The packet is not within the transmission window of the corresponding frame if the frame SN is not in the range defined by the minimum frame SN and the maximum frame SN. The packet-dropping layer delivers the packet to a lower layer (e.g., an RLC layer) when the packet identity of the packet is within a transmission window of the corresponding frame. The packet-dropping layer drops the packet when the packet identity of the packet is not bounded within the transmission window of the corresponding frame. The embodiment of the disclosed method may be embodied as algorithm shown in the following:

| ● | When an RLC entity is configured for an XR service, | |
|---|---|---|
| | ▪ | the Window_size for the transmission window is configured for each XR stream; |
| | ▪ | the timer t_frame_transmission is configured for each XR stream and reset for |
| | | each frame of the XR stream; |
| ● | In the RLC entity, each service data unit (SDU) received from an upper layer comprises | |
| | a packet of a frame of the XR stream, and the packet carries a frame SN for the packet; | |
| ● | When the RLC entity receives an SDU, | |
| | ▪ | If the timer t_frame_transmission is not running, |

| | |
|---|---|
| ♦ | start the timer t_frame_transmission and set the minimum frame |
| | SN Minimum_frame_SN as the frame SN; |

| | |
|---|---|
| ▪ | Else |

| | |
|---|---|
| ♦ | If the frame SN < Minimum_frame_SN or frame SN >= |
| | (Minimum_frame_SN + Window_size), |
| | ● Discard the SDU; |
| ♦ | Else |
| | ● Deliver a PDU corresponding to the SDU to the lower layer. |

| ● | If the timer t_frame_transmission is expired, | |
|---|---|---|
| | ▪ | Set Minimum_frame_SN as Minimum_frame_SN +1; |
| | ▪ | Reset and restart timer t_frame_transmission; |

The timer t_frame_transmission may be configured as an integer multiple of the periodicity of the frame. The information regarding the frame SN for the packet in each SDU may be received from the PDCP layer in the form of an inter-layer service or the SDU header. For example, in an embodiment, the RLC layer receives the frame SN information for each SDU synchronously from the PDCP layer. In another embodiment, the RLC layer retrieves and removes the frame SN information from the SDU header and obtains the remaining portion of the SDU as the final SDU for the RLC entity.

In another embodiment, the timer t_frame_transmission may be set to one of two values, t1 and t2. The t1 is configured for the first frame, and the t2 is configured for other frames. Generally, t1 is greater than t2. Each of t1 and t2 may be configured as integer multiples of the periodicity of the frame.

For configuration of the Window_size and timer t_frame_transmission, the gNB 20 may acquire the configuration information of the Window_size and timer t_frame_transmission from UE in a radio resource control (RRC) message or a medium access control (MAC) control element (CE) via NR Uu interface or from an AMF (Access and Mobility Management Function) in an NG application protocol (NGAP) message via NG interface as illustrated in FIG. 19.

The transmitter device may determine the configuration of the Window_size and the t_frame_transmission based on one or more parameters of the QoS requirements and/or characteristics of the XR service and XR client capabilities. The XR client capability parameters represent various capabilities of one or more XR clients, such as the transmitter device and/or the receiver device. In an embodiment, the parameters may include but are not limited to one or more of the following parameters associated with the XR service:
QoS requirement parameters;
Traffic characteristics parameters; and
XR client capability parameters.

QoS requirement parameters comprise one or more of:
packet delay budget (PDB);
packet error rate (PER);
packet loss rate (PLR);
frame error rate; and
frame delay budget.

Traffic characteristics parameters comprise one or more of:
resolution;
frame rate;
frame size; and
data rate.

XR client capability parameters comprise one or more of:
a buffer capability of an XR client for the XR service.

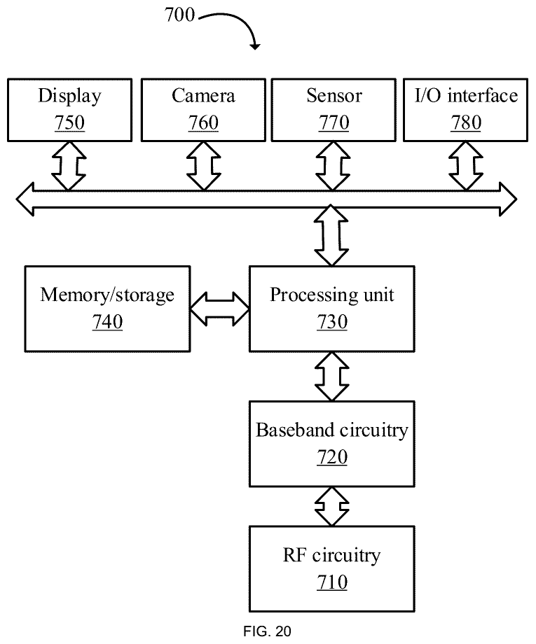

FIG. 20 is a block diagram of an example system 700 for wireless communication according to an embodiment of the present disclosure. Embodiments described herein may be implemented into the system using any suitably configured hardware and/or software. FIG. 20 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

In various embodiments, the system 700 may be a mobile computing device such as, but not limited to, a laptop computing device, a tablet computing device, a netbook, an ultrabook, a smartphone, etc. In various embodiments, the system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that can be adopted in 3GPP specification to create an end product.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

In the embodiments of the disclosure, a video frame of an XR service may be segmented into one or multiple packets for transmission on a network periodically.

Embodiments of the invention provides:
A method for identifying packets of a frame in the transport network.
A method for transporting the identifier of a packet of a frame based on the Real-time Transport Protocol (RTP) protocol and RTP header extension.
A method for dropping obsolete packet(s) for a frame based on a timer, a transmission window, and an identifier identifying the frame.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A wireless communication method, executable in a communication device, comprising:
retrieving, by a header processing laver, identification information of a packet and/or a packet group to which the packet belongs in a header extension of a real-time transport protocol (RTP) header of the packet;
wherein the header processing laver is not a peer laver of a RTP layer.

2. The method of claim 1, wherein the identification information comprises a packet group identifier and/or a packet identifier.

3. The method of claim 2, wherein the identification information is a packet serial number (SN) and/or packet-group-common SN that is incremented for each predefined number of consecutive different packet groups.

4. The method of claim 2, wherein the identification information is inserted into a protocol data unit (PDU) header of each packet among packets of the packet group in an identifier inserting layer.

5. The method of claim 2, wherein the identification information is inserted into a header extension of a real-time transport protocol (RTP) header in the PDU header.

6. The method of claim 5, wherein a field “X” in the RTP header is set “1” to indicate that one or more header extensions carrying the identification information are in the RTP header.

7. The method of claim 6, wherein the identification information comprises the packet-group-common identifier only.

8. The method of claim 6, wherein the identification information comprises the packet-group-common identifier and the packet identifier.

9. The method of claim 1, further comprising:
delivering the packet to a lower layer when the packet identity of the packet is within a transmission window of the packet group; and
dropping the packet when the packet identity of the packet exceeds the transmission window of the packet group;
wherein the transmission window is configured for the a service stream, and the transmission window is delimited by a minimum packet-group-common serial number (SN) and a maximum packet-group-common SN.

10. The method of claim 9, wherein the identification information comprises a packet-group-common SN of the packet group, the packet is within the transmission window of the packet group if the packet-group-common SN is in a range defined by the minimum packet-group-common SN and the maximum packet-group-common SN, the packet is not within the transmission window of the packet group if the packet-group-common SN is not in the range defined by the minimum packet-group-common SN and the maximum packet-group-common SN.

11. The method of claim 9, wherein the maximum packet-group-common SN is determined by the minimum packet-group-common SN and a predefined window size of the transmission window.

12. The method of claim 9, wherein the transmission window slides when a timer of the transmission window expires by means of adding 1 or a predefined value to the minimum packet-group-common SN to form a new value of the minimum packet-group-common SN of the transmission window.

13. The method of claim 9, wherein the window size of transmission window and the timer are determined based on one or more of:
quality of service (QoS) requirement parameters of a service;
traffic characteristics parameters of the service; and
client capability parameters of the service.

14. The method of claim 13, wherein configuration information of the window size and the timer is transmitted in a radio resource control (RRC) message or a medium access control (MAC) control element (CE) via NR Uu interface or in an NG application protocol (NGAP) message from an access and mobility management function (AMF) via NG interface.

15. The method of claim 13, wherein the QoS requirement parameters of the service comprises one or more of:
packet delay budget (PDB);
packet error rate (PER);
packet loss rate (PLR);
frame error rate; and
frame delay budget.

16. The method of claim 13, wherein the traffic characteristics parameters comprise one or more of:
resolution;
frame rate;
frame size; and
data rate.

17. The method of claim 13, wherein the client capability parameters of the service comprise:
a buffer capability of the client of the service.

18. The method of claim 1, further comprising:
retrieving and removing the identification information from the PDU header of the packet,
the retrieving and removing of the identification information from the PDU header of the packet is performed in a header processing layer of the source point of the packet;
the determining as to whether to drop the packet associated with the identification information, the delivering of the packet, and the dropping of the packet are performed in a packet-dropping layer of the source point of the packet.

19-21. (canceled)

22. A wireless communication device comprising:
a processor, configured to call and run a computer program stored in a memory, to cause a device in which the processor is installed to execute the method of claim 1.

23-26. (canceled)

27. The method of claim 1, wherein the identification information is inserted in the header extension of the RTP header by a source point of the packet.
